(19) United States
(12) Patent Application Publication
(10) Pub. No.: US 2002/0196203 A1
(43) Pub. Date: Dec. 26, 2002

(54) Cathode ray tube of the index tube type

(75) Inventors: Marcellinus Petrus Carolus Michael Krijn, Eindhoven (NL); Hendrikus Bernardus Van Den Brink, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/135,352

(22) Filed: Apr. 30, 2002

(30) Foreign Application Priority Data
May 3, 2001 (EP) 01201608.5

(51) Int. Cl. G09G 1/28; G09G 5/00

(52) U.S. Cl. 345/22

(57) ABSTRACT

A picture display device comprising a cathode ray tube of the index type for producing a single electron beam (7) and having a pattern of index elements and parallel phosphor lines (R,G,B). An index signal is produced during operation. The single electron beam (7) is scanned parallel to and across the phosphor lines and the intensity of the electron beam is maintained substantially constant for each pixel, while the dwell times (tr1, tg1, tb1) on the respective phosphor lines (R,G,B) are chosen to produce the desired color.

### DESCRIPTION OF THE PRIOR ART

The invention relates to a picture display device comprising a cathode ray tube having means for generating a single electron beam, a display screen provided with a phosphor pattern comprising phosphor stripes luminescing in different colours and index elements inside an evacuated envelope, and means for deflecting the electron beam across the display screen over the phosphor stripes and over the index elements, scanning the electron beam in a direction parallel to the phosphor lines and having means for moving the electron beam alternately in a direction perpendicular to the phosphor lines and imparting video information to the means for generating the electron beam, the picture display device comprising receiving means for receiving data emanating from the index elements, and means for controlling the deflection and/or shape of the electron beam in response to said data.

Picture display devices of the index type are known and are usually referred to as ‘index’ display devices. As compared with the conventional picture display device, in which the cathode ray tube is provided with a colour selection electrode (also referred to as shadow mask), such index display devices have the advantage that, due to the absence of the shadow mask, they have a smaller weight. They require less energy and the sensitivity to vibrations and temperature differences and variations is reduced. This is offset by the fact that, due to the absence of the shadow mask, the sensitivity to disturbing effects of parasitic (electro)-magnetic fields, including the earth's magnetic field, is much greater and much more stringent requirements are imposed on the accuracy with which the beams are generated and deflected.

To obviate and/or reduce the above-mentioned drawbacks, the display screen of an index display device is provided with index elements with which the position and/or the shape of the electron beam(s) can be controlled while they are being deflected across the display screen and over the index elements, which control data are used to correct the deflection and/or shape of the electron beam(s).

A picture display device of the type described in the opening paragraph is known from U.S. Pat. No. 3,147,340. In this patent, a cathode ray tube display device is described in which the electron beam is scanned over the phosphor lines and is deflected, during a scan, in a direction perpendicular to the direction of scan, alternately impinging upon a green, red and blue phosphor line. To this end, the electron beam performs a sinusoidal movement in said direction and the video information for each colour is imparted to the cathode when the electron beam impinges upon a corresponding phosphor line. The intensity of the electron beam corresponds to the amount and intensity of the relevant colour at the relevant spot.

Although the known device has the advantage of using only one electron beam, a number of disadvantages occur. It is difficult to obtain a high intensity, high colour fidelity image. For colour purity reasons, the phosphor lines are spaced in the known display device, reducing the maximum possible intensity. Also the colour rendition is dependent on the mid-point of the sinusoidal movement vis-a-vis the phosphor lines.

Furthermore, the cathode for the single electron beam has to be operated at three times the video frequency, which is difficult to obtain in a secure manner.

### SUMMARY OF THE INVENTION

It is an object of the invention to provide a cathode ray display device which has an improved performance and in which one or more of the above problems are reduced.

To this end, the display device in accordance with the invention is characterized in that, in operation, the electron beam current is maintained substantially constant for each pixel of the image, and the device comprises means for regulating the time during which the electron beam impinges for each pixel on a phosphor stripe of a particular colour, dependent on the colour of the pixel, said means comprising a deflector means for deflecting the single electron beam for controlling the time during which the electron beam impinges on a phosphor stripe of a particular colour, dependent on the colour corresponding to said pixel.

In the known device, the color rendition of each pixel is dependent on the intensity of the electron beam on a particular color phosphor line and on the dwell time, i.e. the time during which the electron beam impinges on each of the particular color phosphor lines. The dwell time itself is highly dependent on the accuracy of the scan. If the scan is too high or too low, one of the colors is too bright and the other too low, and any error in the position has two, mutually enforcing errors as a consequence.

In the device in accordance with the invention, this problem is greatly reduced, because the intensity is constant for a pixel and the dwell times are less dependent on the actual position of the beam.

The deflector means can be integrated in the deflection unit or may be a separate coil system in front of or behind the deflection unit. However, the bandwidth of operation of the main deflection unit is less suitable for the high frequency at which the deflector has to operate. Special coil systems, which are usually smaller, are better suited for this purpose but still leave room for improvement.

Using electro-static deflectors (basically pairs of electrodes between which a voltage difference is applied) is better suited for the high frequencies involved. These electrostatic deflectors can be positioned in front of and behind the main lens portion of the electron gun.

Positioning the deflectors in front of the main lens portion is more advantageous than positioning them behind the main lens portion because the changing deflection current can then be superpositioned on a relatively low voltage instead of being superpositioned on the high anode voltage.

Using only one pair of electrodes would mean that a change of position of the electron beam on the screen would also involve a change of position of the electron beam in the main lens portion. Using two pairs of electrodes (or more) enables the position of the electron beam on the screen to be varied while yet substantially keeping the position of the electron beam in the main lens (and thereby many of the characteristics of the electron beam as apparent on the screen) constant.

Combination of all these advantageous embodiments (which may be used separately) provides a most preferred embodiment in which the means for generating a single electron beam comprises an electron gun having a main lens portion and the deflector means comprises a series of at least two pairs of electrodes in front of the main lens portion of the electron.

These and other aspects of the invention are apparent from and will be elucidated with reference to the embodiments described hereinafter.

### BRIEF DESCRIPTION OF THE DRAWINGS

In the drawings:

FIG. 1 shows schematically a cathode ray tube,

FIG. 2 shows schematically a detail of a known picture display device.

FIG. 3 shows schematically the basic principle of a picture display device according to the invention.

FIG. 4 shows an electron gun for use in a device according to the invention in which two pairs of electrodes for electro-statically deflecting the electron beam are integrated in the electron gun in front of the main lens portion.

FIG. 5 illustrates schematically a driving scheme.

The Figures are not drawn to scale. Generally, identical components are denoted by the same reference numerals in the Figures.

### DESCRIPTION OF PREFERRED EMBODIMENTS

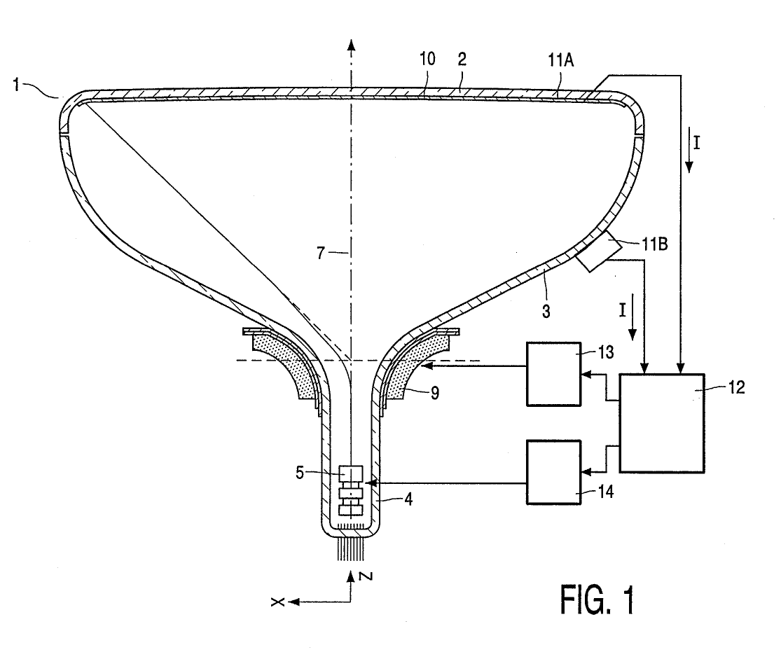

The cathode ray tube shown in FIG. 1 is a colour cathode ray tube 1 having an evacuated envelope comprising a display window 2, a cone 3 and a neck 4. The neck 4 accommodates an electron gun 5 for generating one electron beam 7, in this embodiment, in one plane, the in-line plane. A display screen 10 is situated on the inner side of the display window 3. The display screen 10 comprises a plurality of red, green and blue-luminescing phosphor elements. Each group of (red, green or blue) phosphor elements forms a pattern. The display screen may also comprise other patterns such as a black matrix (a black pattern) or color filter patterns. The electron beam is scanned across the display screen by means of, in this example, an electro-magnetic deflection unit 9. The display screen is provided with patterns with index elements in cathode ray tubes of the index type. The signals emanating from said index elements are detected by detection means, for instance a pattern of (UV) light emitting index element 11A on the screen in conjunction with an light detector 11B, or a pattern 11A of electrically conducting index elements. As the electron beam(s) pass over them, these index signals are indicative of the position and/or shape of the electron beam(s). These index signals are sent to a means 12 for analysis. Usually, said means comprises means for deriving control signals for controlling the deflection and/or shape of the electron beams which are sent to e.g. a means 13 to impart correction currents to the deflection unit 9 or to an additional coil on the deflection unit 11 (here not shown) or to an electrode in or near the electron gun 5 via means 14.

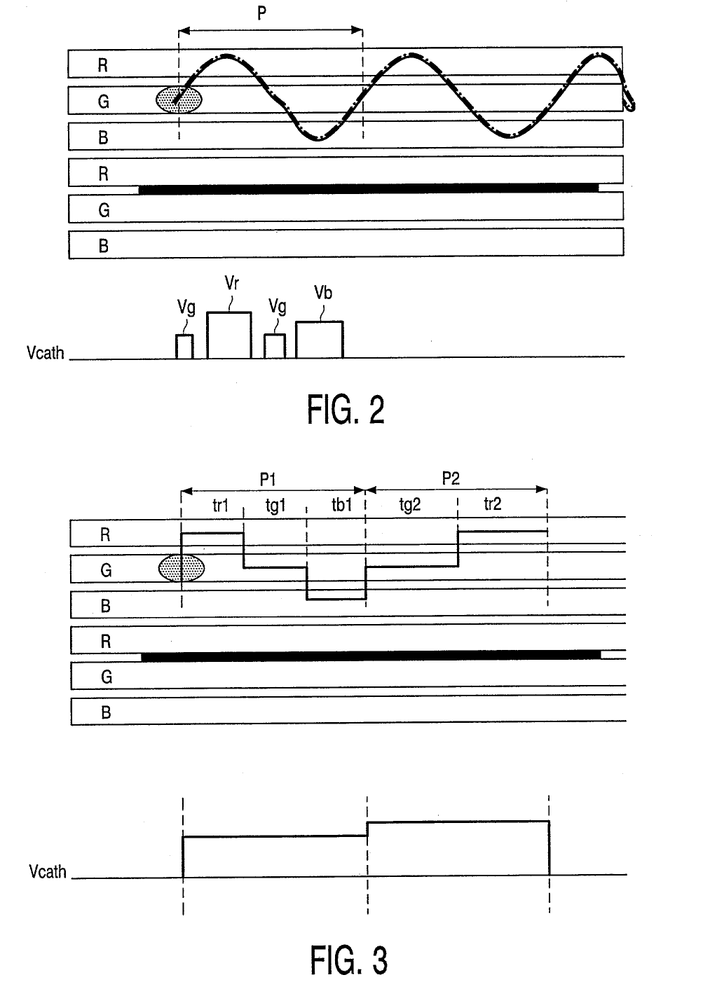

FIG. 2 shows schematically a detail of a picture display device known from U.S. Pat. No. 3,147,340. The display screen 10 comprises phosphor lines R, G, B spaced apart from each other. The electron beam performs a sinusoidal movement (indicated by the drawn sinusoidal line with a period P, corresponding to an image pixel). The black line represents an index element. The cathode voltage (and therewith a measure for the beam intensity) is indicated below the schematic representation of the phosphor screen and the movement of the electron beam across the phosphor screen

As the beam scans the phosphor lines, the intensity is varied as indicated. Two problems arise. The frequency of change in the cathode voltage is very high (three times the video frequency) and even a slight offset in a direction transverse to the phosphor lines greatly influences the color rendition, since it changes the times during which the electron beam impinges on the different lines. If the electron beam is scanned slightly too high, as indicated by the dotted-striped line in FIG. 2, the electron beam impinges on the red phosphor line for a longer time and on the blue phosphor lines for a shorter time. These two negative effects reinforce each other.

The basic principle of the invention is schematically shown in FIG. 3. The position of the electron beam is in altered each pixel between the red, green and blue phosphor lines but the cathode voltage remains the same, i.e. is substantially held constant. During the first pixel P1, the electron beam impinges on the red phosphor line during a time period tr1, on the green phosphor line during time period tg1 and on the blue phosphor line during a time period tb1 in this example. During pixel P2, the electron beam impinges on the green phosphor line during tg2 and on the red phosphor line during tr2.

An upward or downward shift of the phosphor line does not (in a first order approximation) have an effect on the color rendition. Secondly, the cathode voltage is changed much less in frequency (at the video frequency instead of at three times the video frequency) and generally also less in amplitude changing with the overall intensity rather than with the intensity for each color. Furthermore, on average, the efficiency is increased.

It is to be noted that the cathode voltage is held substantially constant. Inevitably, there are some transitional effects when the cathode voltage is changed from one level to another level, i.e. a rising and/or a sloping flank. It is important that one and only one step is made per pixel so that the cathode voltage is changed much less in frequency than in the situation shown in FIG. 2. It is noted that these flanks themselves change the color rendition to some extent. The effect of a large step on the color rendition is greater than the effect of a small step. Also in this respect, the invention as schematically shown in FIG. 3 is advantageous as compared with the situation shown in FIG. 2, because fewer cathode voltage steps are needed and, on average, the cathode voltage steps are smaller.

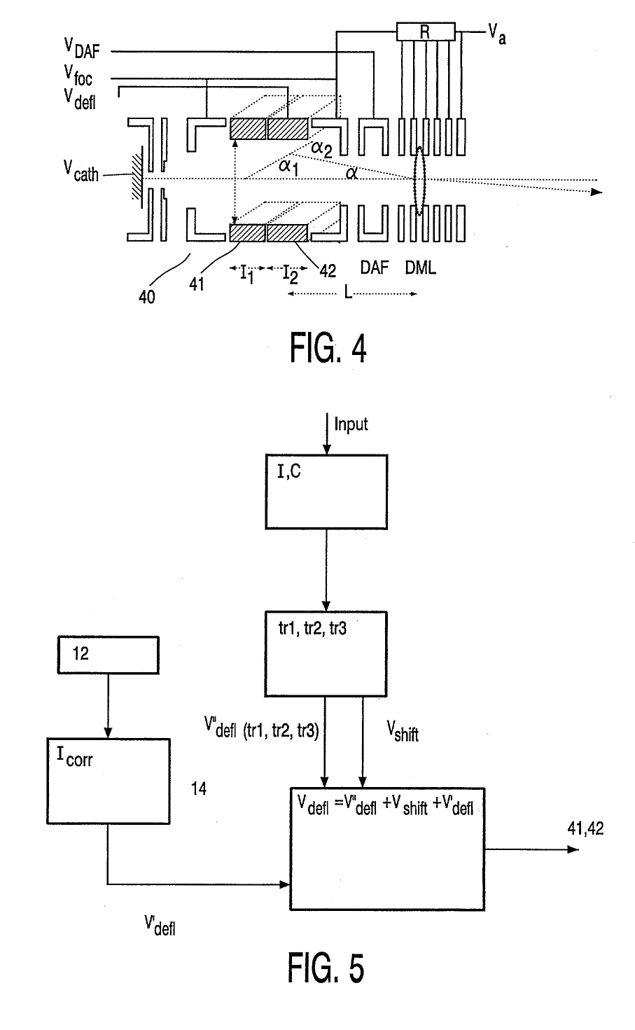

Preferably, the pixels are written in the sequence RGB, BGR, RGB, BGR, i.e. the sequence of writing the red and blue phosphor is altered between adjacent pixels. This reduces the number of movements perpendicular to the phosphor stripes the electron beam has to make by one-third. Preferably, if the color is such that tg1 is very small as compared to both tr1 and tb1, the centre line of the movement of the electron beam is shifted from green to red (or blue), i.e by one phosphor line. In the scheme as schematically shown in FIG. 3, a color with much red and blue, but very little green is difficult to produce, since the electron beam always has to cross over from the red phosphor line to the green phosphor line. This will take a finite time, thus tg1 will be larger than said finite time, so the color will always comprise a green component. By shifting the centre line one third of a triplet i.e. one phosphor line, the green phosphor line need not be crossed and colors with no or only a very small green component can be obtained. Such a shift can either be performed by the overall deflection system 9 or by a deflection system as described in FIG. 4.

The deflector means can be integrated in the deflection unit or by a separate coil system in front of or behind the deflection unit. However, the bandwidth of operation of the main deflection unit is less suitable for the high frequency at which the deflector has to operate. Special coil systems, which are usually smaller are better suited, but still leave room for improvement.

Using electro-static deflectors (basically pairs of electrodes between which a voltage difference is applied) is better suited for the high frequencies involved. These electrostatic deflectors can be positioned in front of and behind the main lens portion of the electron gun.

Positioning the deflectors in front of the main lens portion is more advantageous than positioning them behind the main lens portion because the changing deflection current can then be superpositioned on a relatively low voltage instead of being superpositioned on the high anode voltage.

Using only one pair of electrode would mean that a change of position of the electron beam on the screen would also involve a change of position of the electron beam in the main lens portion. Using two pairs of electrodes (or more) enables the position of the electron beam on the screen to be varied while yet substantially keeping the position of the electron beam in the main lens (and thereby many of the characteristics of the electron beam as apparent on the screen) constant.

Combination of all these advantageous embodiments (which may be used separately) provides a most preferred embodiment in which the means for generating a single electron beam comprises an electron gun having a main lens portion and the deflector means comprises a series of at least two pairs of electrodes in front of the main lens portion of the electron.

An electron gun for such an embodiment is schematically shown in FIG. 4.

The deflector is integrated in the electron gun and, in this example, positioned inside the focus bus of the gun and comprises two pairs of electrodes 41 and 42 for generating, in this example, two consecutive deflection dipoles generating vertical deflection fields with opposite signs. Indicated in the Figure are the main lens part, which in this example is a distributed main lens (DML), the first electrode of which is fed in operation with the anode voltage (Vₐ) and distributed across the different electrodes of the distributed main lens part. Viewed from the cathode to which the cathode voltage V_{cath} is supplied in operation is a Dynamic Astigmatism and Focusing electrode DAF which is preceded by the focus bus 40. The focus bus voltage V_{foc} is supplied to the focus bus. Two electrostatic deflectors in the form of the two pairs of electrodes 41 and 42 are provided inside the focus bus. The electrodes are through-connected, as is schematically indicated in FIG. 4. The first of the electrostatic deflectors deflects the electron beam across an angle alpha1, the second redeflects the electron beam back to the central line. A difference between the deflection voltage V_{defl} and the focus voltage V_{foc} brings about a deflection of the electron beam in the vertical direction. Preferably, the excitation of the two pairs of electrodes is chosen to be such that, in a first order approximation, the position of the beam (but not the entrance angle alpha) in the main lens is independent of the excitation of the electrodes in order not to change the spot performance, but only the position of the spot on the screen. Preferably, the lengths of the electrodes are chosen to be such that the electrodes of both pairs can be through-connected (as schematically indicated in FIG. 4) which obviates the need for two separate deflection voltages. The deflection voltage for obtaining a shift of 100 μm is typically in the range of several tens of volts, which can easily be superposed on the focus voltage. It is noted that, in preferred embodiments, the deflector is used simultaneously for shifting the position as schematically indicated in FIG. 2 but also for indexing purposes, in other words, reacting to index signals from means 14. In this manner, the deflector serves two purposes, namely performing index corrections and shifts for color rendition without this having any influence on the spot performance.

FIG. 5 illustrates schematically a scheme for driving a deflector. The intended intensity I and the colour C of the pixel can be calculated from the input data. The dwell times tr1, tr2, tr3 are calculated from this data. The deflection voltage V″_{defl} is calculated therefrom and possibly also a shift voltage V_{shift} to shift the pixel by a phosphor line in accordance with a preferred embodiment. Furthermore, means 12 supplies correction data I_{corr} to means 14, from which correction data a deflection voltage V′_{defl} can be calculated. The sum of all these voltages is calculated and applied to electrodes 41, 42.

In summary, the invention may be described as follows.

A picture display device comprising a cathode ray tube of the index type for producing a single electron beam and having a pattern of index elements and parallel phosphor lines. An index signal is produced during operation. The single electron beam is scanned parallel to and across the phosphor lines and the intensity of the electron beam is maintained substantially constant for each pixel, while the dwell times on the phosphor lines are chosen to produce the desired color.

It will be evident that many variations are possible within the scope of the invention.

1. A picture display device comprising a cathode ray tube (1) having means (5) for generating a single electron beam, a display screen (10) provided with a phosphor pattern comprising phosphor stripes luminescing in different colours and index elements inside an evacuated envelope, and means (9) for deflecting the electron beams across the display screen over the phosphor stripes and over the index elements, scanning the electron beam in a direction parallel to the phosphor lines and having means for moving the electron beam alternately in a direction perpendicular to the phosphor lines and imparting video information to the means for generating the electron beam, the picture display device comprising receiving means (12) for receiving data emanating from the index elements, and means for controlling the deflection and/or shape of the electron beam in response to said data, characterized in that, in operation, the electron beam current is maintained substantially constant for each pixel of the image, and the device comprises means for regulating the time during which the electron beam impinges for each pixel on a phosphor element of a particular colour, dependent on the colour of the pixel, said means comprising a deflector means for deflecting the single electron beam for controlling the time (tr1,tg1,tb1) during which the electron beam impinges on a phosphor element of a particular colour, dependent on the colour corresponding to said pixel.

2. A picture display device as claimed in claim 1, characterized in that, in operation, the pixels are written in the sequence RGB, BGR, RGB, BGR, . . .

3. A picture display device as claimed in claim 1, characterized in that the display device comprises correction means for shifting (V_{shift}) a pixel by one phosphor line in a direction perpendicular to the phosphor lines.

4. A display device as claimed in claim 1, characterized in that the deflector means comprises an electrostatic deflector

5. A display device as claimed in claim 4, characterized in that the display device comprises an electron gun having a main lens portion and the deflector means comprises at least two electrostatic deflectors positioned in front of the main lens portion.

6. A display device as claimed in claim 5, characterized in that the electrostatic deflectors comprise two pairs of electrodes which are through-connected.
